(19) United States
(12) Patent Application Publication
(10) Pub. No.: US 2010/0049541 A1
(43) Pub. Date: Feb. 25, 2010

(54) METHOD OF MANAGING THE WELLNESS OF AN ORGANISATION AND A SYSTEM THEREFOR

(75) Inventors: Alan Pollard, Illovo (ZA); Craig Nossel, Johannesburg (ZA)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(73) Assignee: Discovery Holdings Limited, Sandton (ZA)

(21) Appl. No.: 12/441,447

(22) PCT Filed: Sep. 18, 2007
(86) PCT No.: PCT/IB07/53760

§ 371 Date: Mar. 16, 2009

(30) Foreign Application Priority Data
Sep. 18, 2006 (ZA) 2006/07789

(51) Int. Cl. G06Q 50/00; G06Q 10/00

(52) U.S. Cl. 705/2

(57) ABSTRACT

A method of managing the wellness of an organisation includes providing members of the organisation with access to a plurality of wellness related facilities and/or services and monitoring a plurality of wellness related criteria of the organisation. In addition, awarding the organisation with an award depending on the results of the monitoring of the plurality of wellness related criteria and awarding members of the organisation with an award depending on the results of the monitoring of the plurality of wellness related criteria.

### BACKGROUND OF THE INVENTION

The present invention relates to a method of managing the wellness of an organisation and a system therefor. An example of an organisation could be a corporate employer.

The present invention is predicated on an understanding that the wellness of an organisation is dependent on the wellness of the members of that organisation.

The present invention seeks to address this.

### SUMMARY

According to one example embodiment there is provided a method of managing the wellness of an organisation, the method including:
providing members of the organisation with access to a plurality of wellness related facilities and/or services;
monitoring a plurality of wellness related criteria of the organisation;
awarding the organisation with an award depending on the results of the monitoring of the plurality of wellness related criteria; and
awarding members of the organisation with an award depending on the results of the monitoring of the plurality of wellness related criteria.

The plurality of wellness related facilities and/or services that the member is provided access to may include at least one of;
an infectious disease management programme;
an emergency medical response while located at premises of the organisation; and
a preventative care management programme.

The infectious disease management programme may include a human immunodeficiency virus (HIV) management programme which may include at least one of:
advice on organising an HIV policy;
assistance with legislative compliance;
assistance in developing an HIV/AIDS committee;
voluntary counseling and testing on site for members;
medical advice and counselling;
peer educator training;
support and debriefing for peer educators;
encourage enrolment of HIV positive members onto the HIV programme; and
access to antiretroviral drugs.

The emergency medical response may include a response by emergency medical services.

The preventative care management programme may include medical check ups for members of the organisation.

The plurality of wellness related facilities and/or services that the member is provided access to may also include counselling which may take the form of telephonic or face-to-face counselling.

The plurality of wellness related facilities and/or services that the member is provided access to may include life management skills including legal advice, financial advice and social services assistance.

The plurality of wellness related criteria may include at least one of:
medical claims information pertaining to members of the organisation;
absenteeism information pertaining to absenteeism of members of the organisation from the business of the organisation; and
occupational wellness information pertaining to the occupational wellness of members of the organisation.

According to another example embodiment there is further provided an electronic system for managing the wellness of an organisation, the system including:
a monitoring module to monitor a plurality of wellness related criteria of the organisation;
an awards module to calculate an award for the organisation depending on the results of the monitoring of the plurality of wellness related criteria and to calculate an award for the members of the organisation depending on the results of the monitoring of the plurality of wellness related criteria; and
a database for storing data relating to the use of the plurality of wellness related criteria of the organisation and for storing data relating to the awards for the organisation and the member.

### BRIEF DESCRIPTION OF THE DRAWINGS

FIG. 1 is a flow chart illustrating the methodology of an example embodiment; and

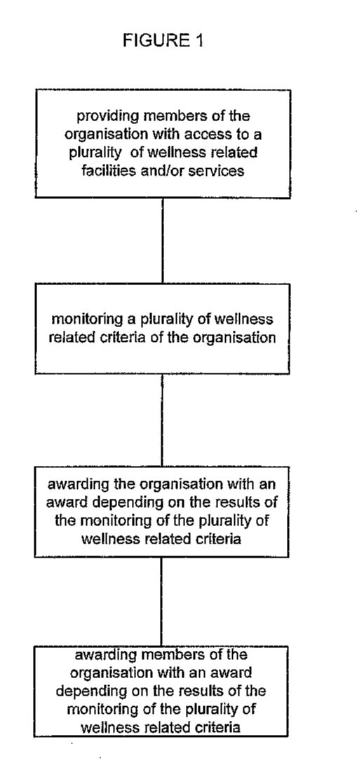

FIG. 2 is a block diagram illustrating an example system to implement the methodologies described herein.

### DESCRIPTION OF EMBODIMENTS

The invention finds application in the field of managing an organisation's health and wellness. The organisation may be a company for example.

According to one example embodiment the method includes providing members of the organisation with access to a plurality of wellness related facilities and/or services.

A plurality of wellness related criteria of the organisation are monitored.

In an example embodiment these include at least one of medical health insurance policy information pertaining to members of the organisation; absenteeism information pertaining to absenteeism of members of the organisation from the business of the organisation; and occupational wellness information pertaining to the occupational wellness of members of the organisation.

The plurality of wellness related facilities and/or services that the member is provided access to includes at least one of infectious disease management programme, emergency medical response and preventative care management programme.

The infectious disease management programme may include a human immunodeficiency virus (HIV) management programme.

The programme could take many forms but will typically include at least one of:
advice on organisation HIV policy;
assistance with legislative compliance;
assistance in developing an HIV/AIDS committee;
voluntary counselling and testing on site for members;
medical advice and counselling;
peer educator training;
support and debriefing for peer educators;
encourage enrolment of HIV positive members onto the HIV programme; and
access to antiretroviral drugs.

The emergency medical response includes at least one of a response by rapid emergency medical services, response by trauma support vehicles, response by critical incident management and first aid training.

The preventative care management programme includes medical check ups for members of the organisation.

In one example embodiment the plurality of wellness related facilities and/or services that the member is provided access includes counselling which may take the form of telephonic or face-to-face counselling. The counselling could be to help a member through any issue that they are struggling with whether related to the organisation or not.

In another example embodiment, the plurality of wellness related facilities and/or services that the member is provided access to also includes life management skills including legal advice, financial advice and social services assistance.

To manage absenteeism the method may include an absenteeism policy development support; managerial training and support; referral health insurance policy; employee assistance and an advice line.

The method may also include awarding the organisation with an award depending on the results of the monitoring of the plurality of wellness related criteria.

The basis for awards will be described below in more detail.

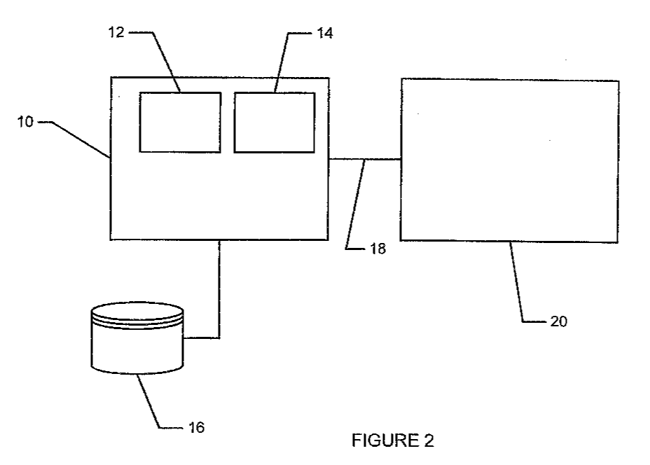

In order to implement the above methodologies, a system as described in FIG. 2 is implemented which will be described below in more detail.

In one example embodiment, the wellness related facilities and/or services may include the following modules:

### Module 1: Wellpoint (Core)

Corporate Health Profile
Health Screening
Executive Medicals
Health Promotion
Health and Wellness Policy Development
Medical Advice Line
Emergency Care

### Module 2: Discovery EAP

Employee Assistance Programme (Counseling and Life Management Services)

### Module 3: Discovery HIVCare

HIV/AIDS Management Programme

The modules can be implemented individually or in combination.

Each of the above will now be described in more detail.

### 1. Corporate Health Profile Health Risk Assessment (HRA)

The HRA is aimed at providing an understanding of the healthy risks that exist in the organisation through self-reported questionnaires
The questionnaires will be available to all employees in either paper based or electronic format. For electronic, this could include:
   Touch-screens available at the organisation all year round or at predetermined times;
   Internet-based; and
   Intranet.

The type of question could include the following:
Age and gender profile
Chronic disease prevalence
Overweight and obesity prevalence
Smoking prevalence
Physical activity status
Nutrition status
Alcohol consumption (abuse)
Resilience
Stage of change
Health perceptions and ‘Healthy Days’

The above parameters will be used to generate a report for the organisation based on the following distributions (included in the HRA):
Age and gender
Staff level
Work type
Business unit
Geographical location

The reports will typically be automated and the frequency of reporting will need to be defined based on response rates and roll-out of the programme.

### 2. Health Screening Benefit

Health screenings are provided to all members of the organisation on-site at the organisations premises.

The screening will typically include the following tests:
Blood pressure
Cholesterol
Glucose
BMI and waist circumference

The tests will be carried out by a network of nurses who are trained and accredited.

Members undergoing the checks will be referred to the appropriate healthcare services based on access and risk Eg. A patient with high blood pressure not on medical aid and not on medication may be referred to the local clinic or the occupational health nurse (if available). Alternatively medical aid members will be referred to their general practitioner for further assessment and treatment.

It will be appreciated that the checks are a convenient health screening and education service. It is not intended to provide treatment for members.

### 3. Executive Medicals

The programme will provide on-site annual executive health check-ups to at least some of the executives of the organisation.

If the programme only offers this to some of the executives and the organisation wants to provide this service to other executives, this will be charged on a fee-for-service basis.

The executive medicals will be provided by a network of doctors who will be trained and accredited.

The report received by the executives will be professionally presented with healthy lifestyle guidelines relevant to the individual and specifically tailored to executive lifestyles.

The doctor who performs the assessment will do a follow-up call or visit and will liaise with the executive's healthcare practitioner should the need arise.

The executive medicals will typically incorporate the following:
Health profile
Medical history
Medical examination
Blood pressure
Cholesterol
Glucose
BMI and waist circumference
Stress ECG
Lung function assessment
Visual assessment
Urine analysis
Liver function tests
Additional blood tests based on medical assessment and health risk

The executive medical examinations create a good opportunity to engage with senior people in the companies and showcase the health and wellness message.

### 4. Health Promotion

To create a culture of wellness within the organisation, to increase awareness, and to ensure a wellness presence, the programme will include general health promotion.

This could include the following on line information:
i. Medical dictionary
ii. Self-care guide
iii. Health and wellness articles
iv. Physical activity guide
v. Nutrition guide
vi. Stress guide
vii. Smoking cessation guide
viii. Assessments/Quizzes
ix. Logbooks
x. Electronic lifestyle/health tips

An electronic newsletter and wellness posters could also be used.

A wellness calendar will focus on the following topics:
i. Physical wellbeing including physical activity and nutrition.
ii. Mental wellbeing and resilience
iii. Preventative care
iv. Safety including drinking responsibly, sun protection, road safety and HIV/AIDS

Healthdays can also be provided to companies on the core programme.

Companies not on the programme will still have access to healthdays, but at an additional market related cost

### 5. Policy Development

This includes advice on Company wellness policies, assistance with legislative compliance and the providing of assistance in developing a wellness committee.

### 6. Medical Advice and Counselling

Medical advice and counselling will be provided to all employees
The service will be provided through Smart Health Choices
The service will include:
24 hour access to a nurse advice line
Emergency medical information
Poison centre
Health and wellness advice

### 7. Employee Assistance Programme (EAP)

The purpose of the EAP is to support and improve the performance of organisations by helping its members to deal with their personal and work-related problems and challenges earlier and more effectively.

It also provides training and education support and guidance for managers and supervisors to assist them with monitoring performance within the organisation and where necessary, to take appropriate action.

All members of the organisation will have access to the employee assistance programme. The service will not be available to family members.

Psychologists located in a call centre provide direct, confidential and unlimited access to a 24 hour personal support service with all calls answered by fully qualified counsellors.

The programme may also offer up to 4 personal counselling sessions per person per year (per condition) close to his or her residence or place of work, for each person entitled to use the scheme, for those for whom short-term psychological counselling is appropriate, and with a further 2 sessions at the discretion of the counselling manager. As mentioned above, all counselling is provided by fully qualified and registered clinicians.

The programme may also offer direct, confidential and unlimited access to a 24 hour LifeManagement Service. The LifeManagement Service is comprised of Legal, Financial and FamilyCare services. The legal service includes telephonic legal advice, the provision of precedents and pro-formas as well as referrals to appropriate legal services and bodies; the financial service is intended to help those employees who require assistance with the management of debt and financial concerns; and the FamilyCare service supports employees to cope with the pressures of caring for their family members (including children with special educational needs and older or disabled relatives) by providing information and guidance on a wide range of welfare issues.

Although the legal service includes information and assistance on a range of legal matters, legal information on Labour Law issues is excluded.

A critical incident service offering prompt and professional trauma debriefing and counselling services to employees exposed to incidents of trauma, for example, for a member involved in an armed robbery.

### 8. Absenteeism Management

The absenteeism management programme provides the infrastructure for organisations to really manage absence well (turning policy into practice).

It provides the data and analysis to drive effective change and helps reduce overall health related costs by managing short frequent absences and mid-to-longer term absences.

The absenteeism management is the enabling tool to help drive change in the organisation.

In addition, line managers will be given guidelines and training and how to manage absent staff:
Abuse
Medical related absenteeism
Disability related absenteeism

Absenteeism data will be provided to HR managers to assist in empowering them. The absenteeism data will be linked to other data points (HRA/HIV/Health Screenings/EAP) to ensure a proactive approach in absence management.

### 9. Emergency Care

Members of the organisation are given access to emergency services for any onsite emergencies.

In addition, First Aid training will be provided to companies to meet health and safety legislative requirements.

### 10. HIVCare

This comprehensive programme includes surveys, HIV education and awareness, voluntary counselling and testing, medical advice and counselling, HIV policy development as well as the HIVCare Management Programme. The programme includes the following for example:

Annual surveys to determine knowledge, attitude and practice are conducted to guide the appropriate HIV strategy in the workplace.

Advice on internal organisation HIV policy. Assistance with legislative compliance is provided. Assistance in developing an HIV/AIDS committee is provided.

Development of a calendar of activities throughout the year, including the scheduling of voluntary counselling and testing.

Provision of HIV articles and poster campaigns.

A peer educator programme and support and debriefing for peer educators is provided.

On-site voluntary counselling and testing for all employees.

HIV-positive members will be encouraged to join the HIV Management Programme.

24-hour access to nurse-based medical advice and counselling phone-line. Additional support through the Employee Assistance Programme (if taken).

Access to antiretroviral medication, doctor consultations and pathology to coordinate and manage treatment. Clinical management and support for employees with HIV.

### 11. Data Reporting

Data from all sources will be integrated to ensure a comprehensive understanding of the existing health and wellness status of each organisation.

The reports will assist in understanding level and engagement as well as outcome based measures.

The methodology described above could be operated in conjunction with an incentive program operated by a health insurer or third party administrator of a health insurance plan.

An example of such an incentive program is presently managed by the applicant which manages a traditional indemnity health insurance plan together with their so-called Vitality™ program disclosed in the applicant's co-pending U.S. patent publication Ser. No. 09/982,274, the contents of which are incorporated herein by reference.

In any event, the plurality of wellness related criteria of the organisation are monitored and the organisation is awarded a wellness status.

For example, the organisation could be awarded points according to a predetermined criteria and the wellness status of the organisation will then be determined by the number of points collected. In one example embodiment the number of points collected could calculated as follows:

The following three categories are included in clinical wellness of the organisation

Members at goal weight

| Bands | Points |
|---|---|
| 0%-20% | |
| 21%-40% | 25 |
| 41%-50% | 50 |
| 51%-70% | 80 |
| 71%-80% | 120 |
| 81%-100% | 150 |

Members with normal blood pressure

| Bands | Points |
|---|---|
| 0%-75% | |
| 76%-80% | 20 |
| 81%-85% | 30 |
| 86%-90% | 50 |
| 91%-95% | 70 |
| 96%-100% | 100 |

Members with normal cholesterol

| Bands | Points |
|---|---|
| 0%-75% | |
| 76%-80% | 25 |
| 81%-85% | 35 |
| 86%-90% | 55 |
| 91%-95% | 75 |
| 96%-100% | 110 |

The following three categories are included in the lifestyle wellness of the organisation:

Members who don't smoke

| Bands | Points |
|---|---|
| 0%-70% | |
| 71%-80% | 15 |
| 81%-90% | 25 |
| 91%-95% | 45 |
| 96%-100% | 65 |

Members who are physically active

| Bands | Points |
|---|---|
| 0%-20% | |
| 21%-40% | 10 |
| 41%-50% | 15 |
| 51%-70% | 20 |
| 71%-80% | 25 |
| 81%-100% | 35 |

Members with good nutrition habits

| Bands | Points |
|---|---|
| 0%-20% | |
| 21%-40% | 10 |
| 41%-50% | 15 |
| 51%-70% | 20 |
| 71%-80% | 25 |
| 81%-100% | 35 |

The following three categories are included in the engagement of the programme by the organisation:

Members completing a Health Risk Assessment

| Bands | Points |
|---|---|
| 0%-25% | |
| 26%-50% | 20 |
| 51%-60% | 40 |
| 61%-70% | 60 |
| 71%-80% | 100 |
| 81%-100% | 120 |

Members doing a preventive screening check-up

| Bands | Points |
|---|---|
| 0%-25% | |
| 26%-35% | 20 |
| 36%-45% | 30 |
| 46%-60% | 40 |
| 61%-75% | 55 |
| 76%-100% | 70 |

Members undergoing voluntary counselling

| Bands | Points |
|---|---|
| 0%-25% | |
| 26%-35% | 30 |
| 36%-45% | 50 |
| 46%-60% | 70 |
| 61%-75% | 100 |
| 76%-100% | 120 |

Where the programme is tied in with the Vitality™ programme of the applicant, the following could also be added:

Members with over 10 000 Vitality points

| Bands | Points |
|---|---|
| 0%-20% | 20 |
| 21%-35% | 35 |
| 36%-50% | 65 |
| 51%-65% | 100 |
| 66%-100% | 120 |

In addition, organisations are awarded points just by taking part in the programme depending on the number of modules that the organisation takes part in. For example, the organisation could be awarded 25 points per module that it engages or alternatively some modules could be weighted to be worth more points, for example 50 points for a more weighted module.

Based on the total amount of points accumulated the organisation could be awarded a status according to the following example embodiment:

### Level 5—Maximum Wellness

801-1 000 points

### Level 4—Healthy

651-800 points

### Level 3—Engaged

501-650 points

### Level 2—Average

351-500 points
Level 1—Below average
201-350 points
Level 0—No activity
0-200 points

Thus by implementing the methodology, organisations will earn a wellness status also referred to herein as a WellPoint™ status. The better their status, the greater the rewards to both the organisation and its members. In the case of employer and employees the better the status the better the reward to the employer and employees.

It is envisaged that the status will be reassessed every quarter to enable the organisation to track their performance and incentivise the behaviour of their members.

It will be appreciated that just by taking part in the programme, organisations will benefit substantially in terms of improved member morale, reduced absenteeism and disability costs as well as increased productivity.

In addition, there are rewards to both the organisation and the member to help motivate healthy behaviour.

An example of such rewards is as follows:

### For the Member:

To incentivise members to actively take part in the programme and increase their wellness, all employees, are encouraged to join the programme. The programme encourages them to be healthy, earn a status and benefit from the various health, lifestyle and leisure rewards.

For example, members may be given a discount when using their credit card or may be given a discount when using their credit card at some selected stores.

The higher the status of the organisation the bigger the discount.

Members could also be given other kinds of rewards such as free or discounted access to services and/or facilities such as aeroplane tickets, hotel accommodation and car rentals to name but a few examples. Cash back rewards are another example of a reward the member could be given.

### For the Organisation

The organisation will, for example, be given a discount on their Group Life insurance premiums or medical insurance premiums to name but two possible examples. This discount increases as the organisation improves its status.

Any other suitable rewards for the organisation could also be awarded.

The above methodologies are implemented in the example system illustrated in FIG. 2.

A server 10 is typically operated by the managers of the programme. The server 10 includes a monitoring module 12 to monitor a plurality of wellness related criteria of the organisation.

An awards module 14 is used to calculate an award for the organisation depending on the results of the monitoring of the plurality of wellness related criteria and to calculate an award for the members of the organisation depending on the results of the monitoring of the plurality of wellness related criteria.

A database 16 is used for storing data relating to the use of the plurality of wellness related criteria of the organisation and for storing data relating to the awards for the organisation and the member.

The server 10 may be connected by a communications network 18 to a further server 20 from where data for the different modules may be obtained to use for the calculations.

The modules described above may be implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

It will thus be appreciated that the method and system described herein exploit the strong relationship between the wellness of members of an organisation and their productivity in the organisation.

In the employer and employee scenario the importance of the workplace in promoting health cannot be understated. Employers are hereby provided with a mechanisms and solutions to harmonize this relationship. Employers that embrace this methodology and system demonstrate their commitment to the wellness of their employees which can ultimately become a powerful tool in the quest for retaining and attracting loyal employees in a highly competitive arena. In addition, this can ultimately result in a positive impact on the organisation's effectiveness.

1. A method of managing the wellness of an organisation, the method including:
providing members of the organisation with access to a plurality of wellness related facilities and/or services;
monitoring a plurality of wellness related criteria of the organisation;
awarding the organisation with an award depending on the results of the monitoring of the plurality of wellness related criteria; and
awarding members of the organisation with an award depending on the results of the monitoring of the plurality of wellness related criteria.

2. A method according to claim 1 wherein the plurality of wellness related facilities and/or services that the member is provided access to include at least one of:
an infectious disease management programme;
an emergency medical response while located at premises of the organisation; and
a preventative care management programme.

3. A method according to claim 2 wherein the infectious disease management programme includes a human immunodeficiency virus (HIV) management programme which includes at least one of:
advice on organising an HIV policy;
assistance with legislative compliance;
assistance in developing an HIV/AIDS committee;
voluntary counseling and testing on site for members;
medical advice and counselling;
peer educator training;
support and debriefing for peer educators;
encourage enrolment of HIV positive members onto the HIV programme; and
access to antiretroviral drugs.

4. A method according to claim 2 wherein the emergency medical response includes a response by emergency medical services.

5. A method according to claim 2 wherein the preventative care management programme includes medical check ups for members of the organisation.

6. A method according to claim 1 wherein the plurality of wellness related facilities and/or services that the member is provided access to also includes counselling.

7. A method according to claim 6 wherein the counselling takes the form of telephonic or face-to-face counselling.

8. A method according to claim 1 wherein the plurality of wellness related facilities and/or services that the member is provided access to includes life management skills including legal advice, financial advice and social services assistance.

9. A method according to claim 1 wherein the plurality of wellness related criteria include at least one of:
medical claims information pertaining to members of the organisation;
absenteeism information pertaining to absenteeism of members of the organisation from the business of the organisation; and
occupational wellness information pertaining to the occupational wellness of members of the organisation.

10. An electronic system for managing the wellness of an organisation, the system including:
a monitoring module to monitor a plurality of wellness related criteria of the organisation;
an awards module to calculate an award for the organisation depending on the results of the monitoring of the plurality of wellness related criteria and to calculate an award for the members of the organisation depending on the results of the monitoring of the plurality of wellness related criteria; and
a database for storing data relating to the use of the plurality of wellness related criteria of the organisation and for storing data relating to the awards for the organisation and the member.

11. A electronic system according to claim 10 wherein the plurality of wellness related facilities and/or services that are monitored by the monitoring module include at least one of:
an infectious disease management programme;
an emergency medical response while located at premises of the organisation; and
a preventative care management programme.

12. An electronic system according to claim 11 wherein the infectious disease management programme monitored by the monitoring module includes a human immunodeficiency virus (HIV) management programme which includes at least one of:
advice on organising an HIV policy;
assistance with legislative compliance;
assistance in developing an HIV/AIDS committee;
voluntary counselling and testing on site for members;
medical advice and counselling;
peer educator training;
support and debriefing for peer educators;
encourage enrolment of HIV positive members onto the HIV programme; and
access to antiretroviral drugs.

13. An electronic system according to claim 11 wherein the emergency medical response monitored by the monitoring module includes a response by emergency medical services.

14. An electronic system according to claim 11 wherein the preventative care management programme monitored by the monitoring module includes medical check ups for members of the organisation.

15. An electronic system according to claim 10 wherein the plurality of wellness related criteria that are monitored by the monitoring module include at least one of:
medical claims information pertaining to members of the organisation;
absenteeism information pertaining to absenteeism of members of the organisation from the business of the organisation; and
occupational wellness information pertaining to the occupational wellness of members of the organisation.
